(19) United States
(12) Patent Application Publication
(10) Pub. No.: US 2003/0070978 A1
(43) Pub. Date: Apr. 17, 2003

(54) Filter for diesel engine fuel

(76) Inventors: Paolo Baracchi, Torino (IT); Claudio Crovetti, Mantova (IT); Sergio Tallano, Porto Mantovano (IT)

Correspondence Address: Modiano & Associati, Via Meravigli 16, Milano, 20123, IT

(21) Appl. No.: 09/979,103

(22) PCT Filed: Mar. 16, 2001
(86) PCT No.: PCT/EP01/03158

(30) Foreign Application Priority Data
Mar. 24, 2000 (IT) M1200A000632

(51) Int. Cl. B01D 27/14

(52) U.S. Cl. 210/315; 210/440; 210/499

(57) ABSTRACT

A filter for Diesel engine fuel, according to the invention, which comprises a filtering mass (5) which is contained within an enclosure (2), said mass (5) being designed to be crossed by the fuel in its path inside the filter between an intake connector (3) and a discharge connector (4), said enclosure (2) comprising a water collection chamber (7) at the bottom, a micromesh (8) being further provided which is adapted to be crossed by the fuel that exits from the filtering mass (5).

### BACKGROUND OF THE INVENTION

The invention relates to a filter for Diesel engine fuel.

It is known that filters inserted in the supply circuit of Diesel engine fuel, commonly known as Diesel fuel, comprise means suitable to separate the water contained in the fuel, but these means are less than fully satisfactory.

A very common type of filter utilizes the phenomenon of coalescence, according to which the microscopic water droplets that pass through the filtering mass mixed in with the Diesel fuel tend to merge along the path leading to the peripheral region of the fibers of said filtering mass, forming drops of a certain size which appear on the surface on which the Diesel fuel exits from said mass.

Some of these drops slide downward along said surface by gravity and collect in a chamber provided at the bottom of the filter, forming a mass of water which is periodically evacuated, but many of the drops escape from the surface, entrained by the Diesel fuel in its motion and thus remain included therein, causing a loss of effectiveness of the filter.

### SUMMARY OF THE INVENTION

The aim of the present invention is to provide a filter for Diesel engine fuel which ensures high efficiency in eliminating water from the fuel.

This aim is achieved by a filter for Diesel engine fuel, according to the invention, comprising a filtering mass which is contained within an enclosure, said mass being designed to be crossed by the fuel in its path inside the filter between an intake connector and a discharge connector, said enclosure comprising a water collection chamber at the bottom, characterized in that it comprises a micromesh which is adapted to be crossed by the fuel that exits from the filtering mass.

### BRIEF DESCRIPTION OF THE DRAWINGS

Further characteristics and advantages of the present invention will become better apparent from the following detailed description of some preferred but not exclusive embodiments of the invention, illustrated only by way of non-limitative example in the accompanying drawings, wherein:

FIG. 1 is a partial sectional view, taken along a longitudinal plane, of the invention according to a first embodiment;

FIG. 2 is a view of a second embodiment of the invention;

FIGS. 3, 4 and 5 are views of three further embodiments of the invention, comprising a sleeve for reinforcing the filtering mass;

FIGS. 6 and 7 are views of two additional embodiments of the invention.

### DESCRIPTION OF THE PREFERRED EMBODIMENTS

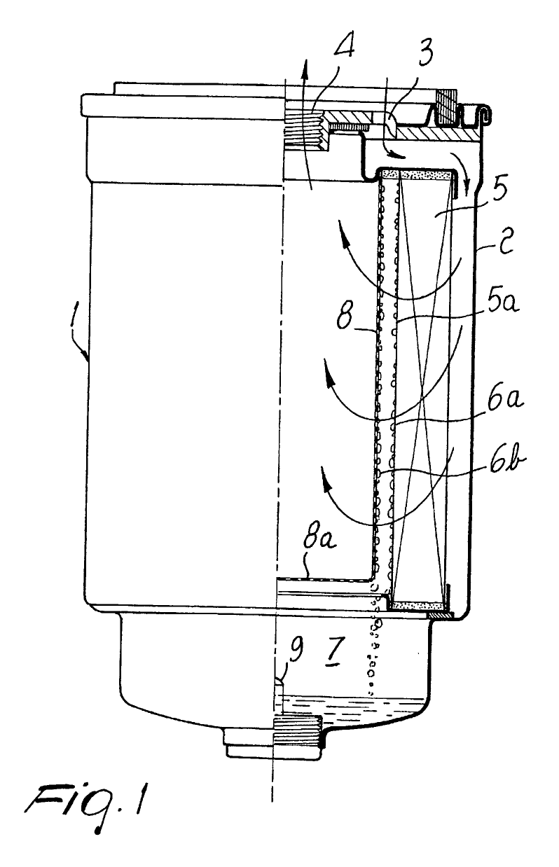

With reference to FIG. 1, reference numeral 1 generally designates a filter which comprises a per se known structure which is adapted to determine, inside the enclosure 2, the circulation of the Diesel fuel indicated by the arrows in the figure between the intake connector 3 located at the enclosure and the discharge connector 4 located in the central region, passing through the filtering mass 5.

The water droplets that have formed by coalescence during the flow of the Diesel fuel through said filtering mass emerge from the surface 5a of said filtering mass, and while some of the droplets, such as 6a, slide by gravity along the surface Sa to collect in the collection chamber 7 provided at the bottom of the enclosure 2, the remaining droplets such as 6b abandon the surface 5a, being entrained by the stream of Diesel fuel, and are captured by the micromesh 8, located proximate to said surface 5a, along which they slide downward so as to reach the chamber 7, which is emptied periodically when indicated by the sensor 9.

A remarkable high efficiency of the filter is thus achieved.

The micromesh 8 has a complete bottom 8a, also made of micromesh, but said bottom might be only partial and provided with a blind surface, and might also be omitted.

The micromesh might also be provided, at its lower end, with a perforated bottom for connection to the filtering mass 5.

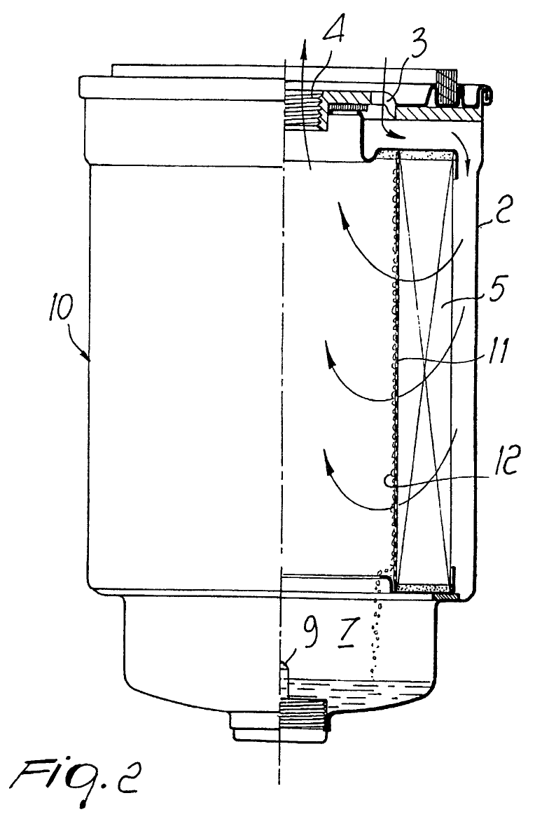

FIG. 2 illustrates a filter 10 having the structure as described above and in which the micromesh 11 is arranged so as to adhere to the surface on which the fuel exits from the filtering mass 5.

The water droplets such as 12 that form by coalescence during the flow of the fuel through the filtering mass 5 are captured immediately by the micromesh 11 and slide downward along it, collecting in the collection chamber 7.

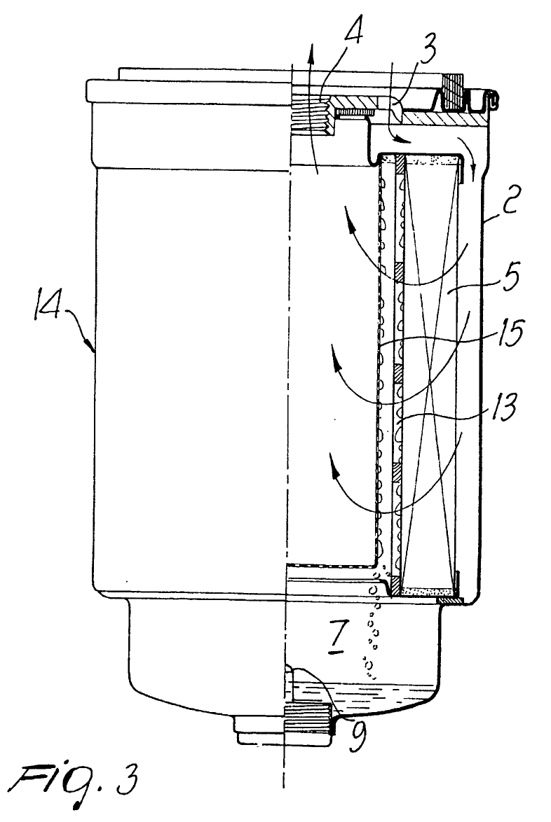

The filters shown in FIGS. 3, 4 and 5 also have a structure as described above, but they also comprise in a known manner the sleeve 13 for reinforcing the filtering mass 5 which is adjacent to the internal surface of said mass.

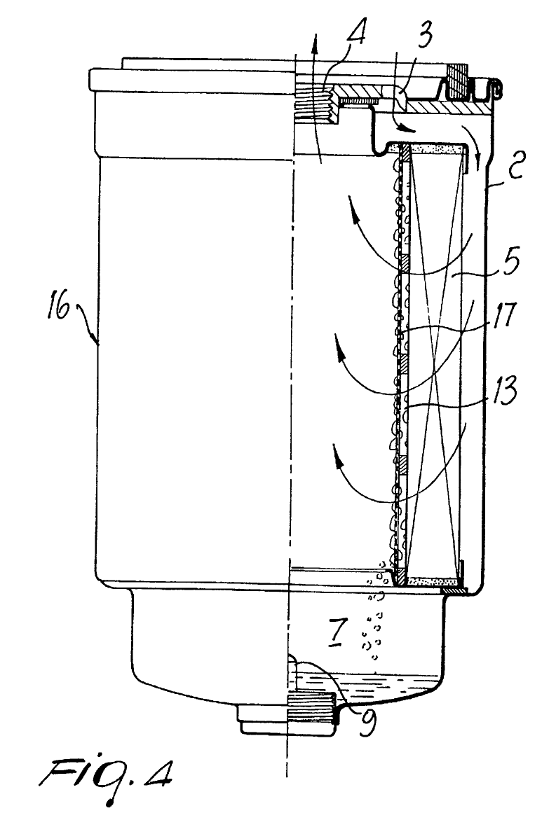

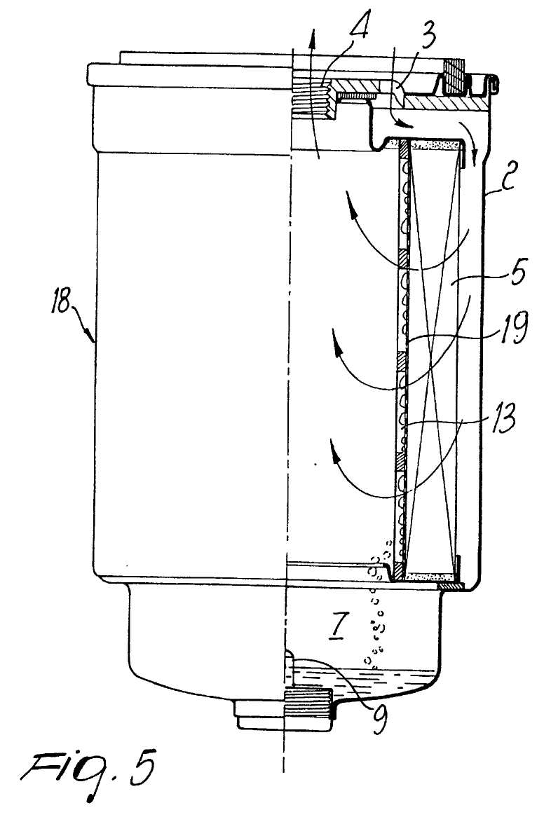

According to the invention, the filter 14 shown in FIG. 3 has the micromesh 15 proximate to the sleeve 13; the filter 16 shown in FIG. 4 has the micromesh 17 in contact with the sleeve 13 on its inner side; and the filter 18 shown in FIG. 5 has the micromesh 19 interposed between the sleeve 13 and the filtering mass 5.

Upon the above description, the functional characteristics of these filters are obvious and are in any case highlighted by the illustration of the water droplets shown in the respective figures; accordingly, an analytical description of said figures is deemed unnecessary.

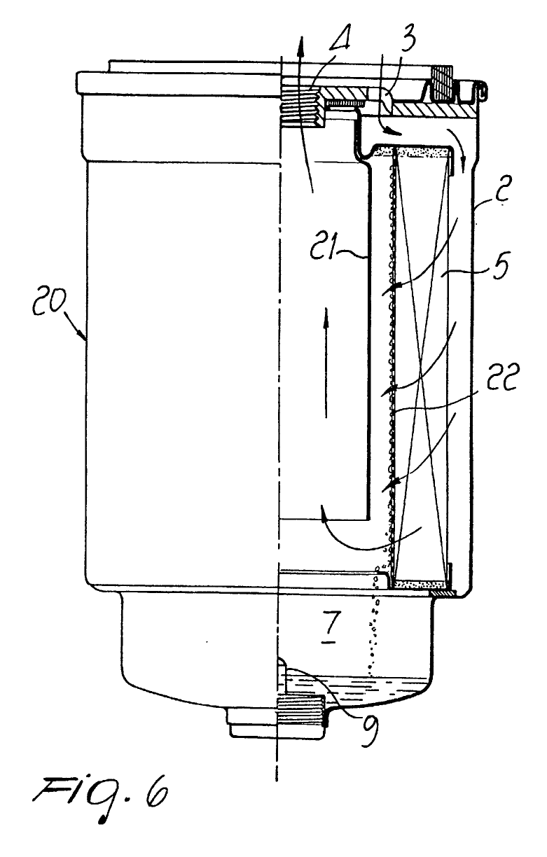

The filter 20 shown in FIG. 6 has a structure as described above and further comprises the blind screen 21, which is suitable to be encountered by the fuel directed toward the discharge.

There is also the micromesh 22, which is located so as to adhere to the surface on which the fuel exits from the filtering mass 5, and variations are possible in which, again in the presence of the blind screen 21, the micromesh can be arranged in the previously described different manners.

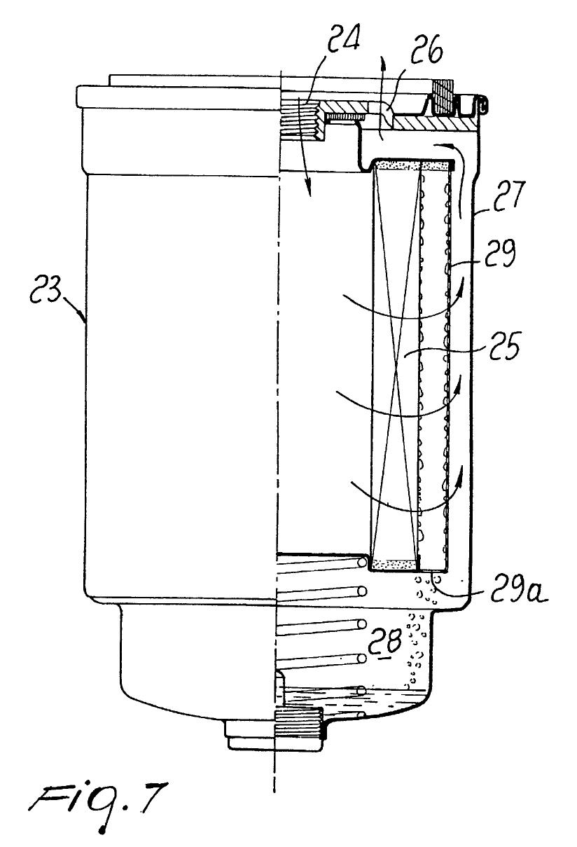

In the filter 23 of FIG. 7, the fuel intake is provided through the connector 24 arranged centrally, and after passing through the filtering mass along the arrows shown in the figures, the fuel exits from the filter through the connector 26 at the outer enclosure 27, which is provided, proximate to the bottom, with the water collection chamber 28.

In this case, the micromesh 29 is arranged outside the filtering mass 25, proximate thereto, and has a perforated bottom 29a for connection to said filtering mass.

Said perforated bottom might be omitted and the micromesh might also be arranged so as to adhere to the outer surface of the filtering mass 25.

The described invention is susceptible of numerous other modifications and variations, all of which are within the scope of the appended claims; all the details may furthermore be replaced with other technically equivalent elements.

The disclosures in Italian Patent Application No. MI2000A000632 from which this application claims priority are incorporated herein by reference.

1. A filter for Diesel engine fuel, comprising a filtering mass which is contained within an enclosure (2), said mass being designed to be crossed by the fuel in its path inside the filter between an intake connector (3,24) and a discharge connector (4,26), said enclosure (2) comprising a water collection chamber (7,28) at the bottom, characterized in that it comprises a micromesh (8,11,15,17,19,22,29) which is adapted to be crossed by the fuel that exits from the filtering mass (5,25).

2. The filter according to claim 1, characterized in that the micromesh is located proximate to the surface (5a) on which the fuel exits from the filtering mass (5).

3. The filter according to claim 1, characterized in that the micromesh (11) is located so as to adhere to the surface (5a) on which the fuel exits from the filtering mass (5).

4. The filter according to one or more of the preceding claims, comprising a fuel intake connector (3) which is located proximate to the enclosure (2), with discharge through a connector (4) located in the central region, characterized in that the micromesh (8) located inside the filtering mass (5) is at least partially provided with a bottom (8a).

5. The filter according to claim 4, characterized in that the bottom (8a) of the micromesh (8) is made of micromesh.

6. The filter according to claim 4, characterized in that the bottom (8a) of the micromesh (8) is provided with a blind surface.

7. The filter according to one or more of the preceding claims, comprising a fuel intake connector (3) which is located proximate to the enclosure (2), with discharge through a connector (4) located in the central region, characterized in that the micromesh (11) located inside the filtering mass is bottomless.

8. The filter according to one or more of the preceding claims, comprising a reinforcement sleeve (13) which is adjacent to the internal surface of the filtering mass (5), characterized in that the micromesh (15) is located proximate to said sleeve (13).

9. The filter according to one or more of the preceding claims, comprising a reinforcement sleeve (13) which is adjacent to the internal s surface of the filtering mass (5), characterized in that the micromesh (17) is arranged so as to adhere to said sleeve (13) on the inner part of said sleeve (13).

10. The filter according to one or more of the preceding claims, comprising a reinforcement sleeve (13) which is adjacent to the internal surface of the filtering mass (5), characterized in that the micromesh (19) is interposed between the sleeve (13) and the filtering mass (5).

11. The filter according to one or more of the preceding claims, characterized in that it comprises a blind screen (21) which is adapted to be encountered by the fuel that exits from the micromesh (22).

12. The filter according to one or more of the preceding claims, characterized in that the micromesh (29) located proximate to the surface on which the fuel exits from the filtering mass (25) has, at its lower end, a perforated bottom (29a) for connection to said filtering mass.
